(19) United States
(12) Patent Application Publication
(10) Pub. No.: US 2006/0246265 A1
(43) Pub. Date: Nov. 2, 2006

(54) Scented packaging and products

(76) Inventors: David E. Rogers, Scottsdale, AZ (US); Elea B. Lutz, Scottsdale, AZ (US)

Correspondence Address: Elea B. Lutz, 14887 North 103rd Street, Scottsdale, AZ, 85255, US

(21) Appl. No.: 11/338,603

(22) Filed: Jan. 23, 2006

Related U.S. Application Data
(60) Provisional application No. 60/645,999, filed on Jan. 21, 2005.

(51) Int. Cl. B41M 5/00

(52) U.S. Cl. 428/195.1

(57) ABSTRACT

A substrate having a scented material is disclosed. The substrate can be any generally flat material capable of being scented by applying a scented material to the substrate by one or more of the following: including scented material into the substrate, applying scented material to one or more surfaces of the substrate, and/or including scented material in a coating, such as a wax, plastic or rubber coating, applied to the substrate. The scented material may be intermittently and/or strategically applied to the substrate.

### CROSS REFERENCE TO RELATED APPLICATIONS

This application claims priority on U.S. Provisional Application No. 60/645,999 filed on Jan. 21, 2005, the disclosure of which is incorporated herein by reference.

### FIELD OF THE INVENTION

The invention relates to scented products, particularly products that include a substrate and one or more scented materials applied to the substrate. The scented material may be applied intermittently and/or strategically in or onto the substrate.

### BACKGROUND

Smell is a sense that enables an individual to perceive the scent (also called an odor or fragrance) of an object (as used herein, “object” refers to any substance, material or thing that has a scent). Throughout history, the sense of smell had been used in virtually every culture and in many religions. For example, in the Greek Orthodox Church incense is burned to appeal to the sense of smell. In Judaism, a spice box including pungent and pleasant spices, such as cinnamon, cloves, and cardamom are used in the Havdalah service, which is held at the end of the Sabbath to start the new week afresh.

Aromatherapy was perhaps first practiced by the ancient Egyptians. Egyptian priests used different scents, generated by burning aromatic substances such as crushed cedarwood bark, caraway seeds, or angelica roots steeped in wine or oil, to either exhilarate or relax their congregations. Kyphi, which is a mixture of sixteen essences, including myrrh and juniper, was used to raise spiritual awareness and heighten the senses. Incense is still used today for much the same purpose.

Scientists are trying to learn more about the power of the sense of smell. Studies have shown that certain smells can be helpful in enhancing relaxation. One of the most well-known studies was done at Sloan-Kettering Memorial Hospital on patients undergoing magnetic resonance imaging (MRI), where a patient must lie motionless while his or her internal organs are scanned. When the vanilla-like aroma of heliotrope was introduced to patients undergoing MRI scans, 63% showed reduced anxiety. In another study at Renssalaer Polytechnic Clinic, it was found that scenting a room with spiced apple or “powder fresh” GLADE air freshener improved performance on a high-stress task. No conclusion was reached as to whether the effects of the fragrance were physical or simply due to cognitive distraction, i.e., the fragrance may have elicited pleasant memories or moods that served as a distraction from anxiety.

The Walt Disney World Magic House at Epcot Center in Florida has a room scented with the smell of fresh-baked chocolate chip cookies to induce feelings of relaxation and comfort. In Japan, the Shimizu construction company uses an “aromatherapeutic environmental fragrancing” system in which air-conditioning ducts hidden in ceiling tiles release a mixture of eight therapeutic aroma chemicals about every six minutes. The system releases different fragrances to improve alertness and concentration, alleviate stress, or to relax workers at the end of the day. Russian psychologists at the Russian Academy of Sciences found that the smells of fruit and flowers can ease the load of computer operators, who spend long hours in front of computer screens each day. Lemon, jasmine or eucalyptus was found to boost productivity and prevent drowsiness.

U.S. Pat. No. 3,570,139 to Ladd, et. al. discloses a book made of sheets having coatings thereon that when scratched give off particular scents and pictures of selected objects, such as peppermint candy, that respectively correspond to the scents.

U.S. Pat. No. 5,918,882 to Truong discloses a game for testing the acuity of the senses and provides questions relating to the senses of touch, taste, hearing and smell of each of the players.

It is known to place scented material, such as a microencapsulated formulation, onto a substrate, particularly paper, card stock or cloth. Such scented material is normally in the form of a single “scratch and sniff” patch, which means that by scratching or rubbing the surface of the scented material, microcapsules are ruptured and release a scent. Such scented material may be an ink that includes microencapsulated formulation. Such scented materials are relatively expensive as compared to non-scented inks, and can increase the cost of a finished product utilizing the ink or scented material.

U.S. Pat. No. 6,669,021 to Spielman discloses a prewrapped gift package having wrapping paper overlying an outer surface of the carton and a sleeve providing indicia describing the gift and affixed to a portion of the wrapping paper.

U.S. Pat. No. 6,343,734 to Smith discloses pre-cut wrapping paper having peel-and-stick adhesive strips. The wrapping paper can be sized and cut to foldably wrap a variety of packages while limiting waste wrap.

Pending U.S. Patent Application Ser. No. 20050054747 discloses a long-lasting scented paint composition and method for creating the scented appoint. According to the abstract, a scenting agent is mixed into a standard paint composition and the resulting mixture will produce an odor or scent that will last after the paint has dried.

Pending U.S. Patent Application Ser. No. 20050048279 to Watson et al. discloses compositions and methods for applying a scented gel carrier, wherein the carrier includes a scent and a matrix to form a scented gel. According to the abstract, the scented gel carrier is able to maintain its scent following washes in cold water and mild detergent.

U.S. Patent Application No. 20040177786 to Durocher discloses a scented paint and surface protectant. According to the abstract it discloses a wax or polish that imports a long-lasting and specific scent to a surface.

Published U.S. Patent Application Ser. No. 20050106077 discloses a long-life scent dispersing mat. According to the abstract of the disclosure, the fragrance as provided in a body, which is a rubber or polymeric sponge soaked with essential oils. The body is inserted into an inner pouch. When the scent-dispersing mat is stepped on, the inner pouch releases saturated fragrant vapor and the vapor is released into the room air.

### SUMMARY OF THE INVENTION

The invention relates to a substrate (such as paper used for gift wrapping) having a scented material included in the substrate and/or applied to one or more surfaces of the substrate and/or included in a coating, such as wax, plastic or rubber, on the substrate (collectively referred to as “applied to” the substrate or “applied thereto”). The substrate is any relatively flat material and preferably can be folded by hand by an adult of normal strength. Exemplary substrates are paper, cardboard, plastic sheet, plastic or metal foil (hereafter, collectively, “foil”), rubber, cloth or a combination of two or more of these. The substrate may have particular dimensions, such as dimensions suitable for gift wrapping, and may be provided in a roll or in individual sheets. The substrate may be formed into various products before or after having scented material applied thereto.

The scented material is any material suitable for imparting a scent to the particular substrate utilized and may be a microencapsulated formulation (such as a scented ink or scratch and sniff material) applied to one or more surfaces of the substrate and/or a material that is included in the substrate, such as an essential oil. Multiple scented materials may be used with a given substrate. For example, a substrate may have applied one or more essential oils applied to it and/or may have one or more scented inks or other microencapsulated formulations applied to it and/or may have one or more coatings including scented material applied to it. If more than one scented material is applied to the substrate, each scented material may have the same scent (for example, each may have the scent of mint) or some or all may have different scents (for example, one could be peanut butter and a second grape and if there were a third, it might have the scent of chocolate).

As previously stated, the scented material may also be included partially or totally in a coating applied to the substrate and/or positioned on such a coating (sometimes referred to herein as a “scented coating”) wherein the coating is a wax, plastic, rubber or other coating. For example, the invention may be a scented wax paper or scented cellophane. Such a coating may be on one or more surfaces of the substrate, and such a coating may partially or completely permeate the substrate (all of such applications of coating including scented material are included in the definition of “applied to” the substrate). If a scented coating is used additional scented material may be applied to the substrate in any other of the previously described manners.

The scented material may be applied to the substrate in any suitable manner depending on the type of substrate and type of scented material. For example, it is known by persons knowledgeable in the fields of making wax paper or other coated papers how to make such products. It is also known by persons knowledgeable in the fields of applying scented inks or applying microencapsulated formulations how to apply such materials to a substrate. Further, persons knowledgeable in the field of scenting paper, plastic, rubber or wax know how to apply essential oils or other substances to such materials to impart a scent to them.

The scented material may be intermittently or strategically applied to (meaning that it is applied to a place on the substrate at which people are likely to detect the scent or where the scent will be associated with a color or design element) the substrate, so that scented material is not applied to the entire substrate. Alternatively, scented material may be applied to substantially all of the substrate.

If applied to the substrate by being positioned on one or more surfaces of the substrate, or by being included in a coating on one or more surfaces of the substrate, scented material may be applied in any suitable manner, including any of the following manners:
(1) substantially covering one or more surfaces of the substrate;
(2) intermittently to one or more surfaces of the substrate, in any pattern or patterns, and the scented material could or could not be associated with one or more design elements on the substrate (for example, the scented material may be an ink and be printed on the substrate as candy canes); and/or
(3) to a given percentage of one or more surfaces of the substrate (for example, at least 15% of the area of the substrate) in order to impart a relatively strong scent.

If applied to the substrate such that it is included in the substrate, scented material may be applied to the substrate in any of the following manners:
(1) substantially throughout the substrate;
(2) intermittently in the substrate in any pattern or patterns and could or could not be associated with one or more design elements on the substrate;
(3) to a given percentage of the substrate, for example, applied to 15% or more of the substrate.

In all such cases, the scented material may or may not have a color, or applied to a portion of the substrate that has a color, and the scent of the scented material may or may not be associated with (also referred to herein as “reminiscent of”) the color. Examples of a scent being associated with a color are (1) mint scent associated with green, (2) vanilla scent associated with white, and (3) banana scent associated with yellow. Additionally, the scented product may or may not include design elements (preferably printed on the substrate or on a coating) and the scent of the scented material may be associated with (or “reminiscent of”) one or more of the design elements. Examples of a scent being associated with a design element are (1) mint scent associated with a candy cane, (2) pine scent associated with a pine tree, and (3) banana scent associated with a banana. Alternatively, the scent need not be associated with a color or design element of the scented product.

If a coating is used, the coating may have one or more colors or design elements.

The scented material may be applied intermittently to the substrate. Some examples of intermittent application of scented material applied to a substrate are (1) in one or more lines, strips or stripes (hereafter, stripes), wherein the stripes can be oriented in any direction (e.g., horizontally or vertically) or in a plurality of directions, and/or (2) in one or more spots, patches, squares, triangles or any shape(s), or combinations thereof, (3) as previously described, applied to one or more design elements and/or one or more of the colors of a design element or any color or colors on the scented product.

Scented material could also be applied to a predetermined amount of the substrate, the amount being determined by the surface area of the substrate to which the scented material is applied to, regardless of the manner in which it is applied (i.e., regardless of whether positioned on one or more surfaces and/or included in or positioned on a coating and/or included in the substrate). For example, from between 10% to 100% of a substrate having dimensions of at least 12″×12″ could include scented material applied thereto.

Alternatively, the scented material may be applied to substantially the entire substrate.

Scented material could also be applied to all or part of the substrate, wherein the scented material and substrate are selected such that the scent of the scented material can be detected by a person having an ordinary sense of smell from a distance of at least 3″, and more preferably from a distance of at least 6″ to 12″ from the scented product.

### BRIEF DESCRIPTION OF THE DRAWINGS

FIG. 1 shows a substrate having scented material placed thereon in a spotted pattern.

FIG. 2 shows a substrate having scented material placed thereon in a lined pattern.

FIG. 3 shows a substrate having scented material placed thereon in an alternate lined pattern.

FIG. 4 shows a substrate having scented material placed thereon in an alternative lined pattern.

FIG. 5 shows a substrate having scented material placed thereon in a crossed lined pattern.

FIG. 6 shows an elongated substrate with a band of scented material running along its longitudinal axis.

FIG. 7 shows an elongated substrate with a line of scented material running along its longitudinal axis.

FIG. 8 shows an elongated substrate with lines of scented material running across the latitudinal axis of the substrate.

FIG. 9 shows an elongated substrate with spots of scented material running in the longitudinal axis of the substrate.

FIG. 10 is a substrate having lines of scented material positioned thereon and an adhesive.

FIG. 11 is a substrate having a section of scented material positioned thereon and an adhesive.

FIGS. 12-13 show an envelope having an adhesive flap and scented material on one or both of the front and back.

FIG. 14 is a substrate having a pattern of scented material, the pattern in the form of repeating candy canes.

FIG. 15 is a front view of a substrate having broad lines along its longitudinal axis, each of the lines having diagonal stripes of scented material therein.

FIG. 16 is a substrate having scented material placed thereon in a pattern of large dots.

FIG. 17 is a substrate having a repeating pattern and including scented material.

FIG. 18 is a substrate having a repeating pattern and including scented material.

FIG. 19 is a substrate having a repeating pattern and including scented material.

FIG. 20 is a substrate in the form of a gift note including scented material.

FIG. 21 is a substrate in the form of a gift note including scented material.

FIG. 22 is an elongated substrate, which is preferably a ribbon, that includes scented material.

FIG. 23 is an elongated substrate, which is preferably a ribbon, that includes scented material.

### DESCRIPTION OF PREFERRED EMBODIMENTS

Exemplary scented products that could utilize the invention are: wrapping paper, gift wrapping paper, calendars, journals, stationary, envelopes, notebook covers, balloons, gift bags, boxes, adhesive (or post-it) notes, ribbon, gift notes, wrapping strand, book marks, books, diary, greeting card, coloring books, posters, clothing, drawer liners, bedding, drapery, floor coverings, towels, wall paper, gift tissue paper, packages including such products and combinations of one or more of these scented products. The following embodiments are exemplary only and are not meant to limit the scope of the invention.

### Substrate

A substrate according to the invention is any material that can have a scented material applied thereto. The substrate is preferably generally flat, thin and pliable so that it can be folded by hand by a person of normal strength. Most preferably, the substrate is a paper, but it could also be cardboard, natural or synthetic cloth, rubber, metal foil or plastic sheet, or any other suitable material. For example, depending upon the application the substrate could be one of the materials disclosed in U.S. Application Publication 20020013108, the disclosure of which is incorporated herein by reference. Some substrates, scented materials and/or methods of applying scented material that may be utilized in the practice of the invention are disclosed: U.S. Pat. No. 6,663,455 and U.S. Pat. No. 6,663,455, the respective disclosures of which are incorporated herein by reference.

### Scented Material

The substrate includes a scented material applied thereto, and in the context of this disclosure “a scented material” means one or more scented materials, and if multiple scented materials are used, they may have the same scent or different scents and may be the same type of scented materials (e.g., microencapsulated formulations) or different types. Any suitable scented material may be applied to a substrate to impart a scent to the substrate, as long as the scent is detectable by a person having at least an ordinary sense of smell.

One scented material that may be used with the invention is a microencapsulated formulation (that may be applied during a printing process), wherein the microcapsules are ruptured when pressure or heat is applied by a user, such as by touching, rubbing or scratching the microcapsules, or by the application of water, a chemical or some other stimulus.

Microencapsulated formulations that release a scent are well known in the art. Some patents disclosing microencapsulated formulations, scented inks or other materials that could be used with the invention are: U.S. Pat. No. 4,661,388 to Charbonneau; U.S. Pat. No. 5,577,947 to Malloy, et. al.; U.S. Pat. No. 6,123,757 to Yang, et. al.; U.S. Pat. No. 6,737,025 to Boyd, et. al.; U.S. Pat. No. 3,655,129 to Seiner; U.S. Pat. No. 3,688,985 to Engel; U.S. Pat. No. 6,261,347 to Moreland; U.S. Pat. No. 6,454,842 to Vernardakis; U.S. Pat. No. 6,706,099 to Sir, et. al.; U.S. Pat. No. 3,909,444 to Anderson, et. al.; and U.S. Pat. No. 6,318,589 to Simpson, the respective disclosures of which are hereby incorporated by reference.

Microencapsulated formulations may be applied to a substrate during a printing process, and this method is known to persons skilled in the art of printing using scented materials. Processes that may be used to apply scented material to a substrate include ink jet printing, screen-print processing, flexo, rotary screen, variable screen printing, silk screening, or any suitable printing process.

Scented material may be a varnish (such as the varnish produced by Druckfarben SRL (www.druckfarbenit) including microencapsulated essences and which can be applied using Flexo, Off-Set, Roto-gravure, Silk-Screen, or Spray and Immersion printing systems.

Scented material may also be applied to the substrate by having a perfume, essential oil or other suitable scented material included in the substrate. This is particularly true for a paper or plastic substrates and the methods of scenting such substrates are known in the art. Polyproplyene or polyethylene film could be used or another polymer that can have a fragrance included, such as by having an essential oil added.

The scented material may also be applied to the substrate as a coating such as a wax, plastic or rubber coating, that includes scented material and/or has it positioned on a surface of the coating. As previously described, scented material may be applied to a substrate using one or more of the techniques described herein. For example, scented material could comprise essential oil enclosed in the substrate and a microencapsulated formulation on a surface of the substrate. If the scented material is applied to the substrate either in whole or in part (as previously described) by being included in a coating, such as wax, plastic or rubber, the coating is preferably wax. In a preferred embodiment, the scented product is wax paper and the scented material is included in the wax. Scented material may additionally be applied to the substrate in any manner previously described or any other suitable manner. The methods of adding scented material to wax, plastic or rubber, and methods of making wax paper or other substrates coated with wax, plastic or rubber, are known to those skilled in the art or can be determined through experimentation.

If a scented coating is applied to a substrate it may be applied to substantially all of the substrate or to any part or portion, and may be applied to multiple locations on the substrate. The scented coating may or may not have a color and its scent may or may not be associated with a color on a scented product or a design element on the scented product.

A scented material according to the invention may have any scent and a non-exhaustive list of possible scents follows: root beer, cola, vanilla, chocolate, mint, peanut butter, apple, orange, grapefruit, peach, cinnamon, leather, ocean, burning rubber, cut grass, carrot, hard-boiled egg, butterscotch, strawberry, banana, blueberry, bubblegum, lavender, rose, pepper, clove, coffee, tea, tomato sauce, oregano, mustard, magic marker, pumpkin pie, raspberry, lemon, vinegar, dill, pineapple, sour apple, almond extract, licorice, cotton candy, popcorn, cherry, pine, chicken noodle soup, macaroni and cheese, hot dog, ginkgo, olive, apple pie, BBQ, birthday cake, candy corn, caramel, cheddar cheese, cherry pie, chili, fish, fresh bread, gingerbread, hamburger, pecan pie, hot dog, jelly bean, licorice, marshmallow, Mexican food, popcorn, pumpkin pie, roast beef, lemon lime, spaghetti, waffle, honey, root beer, spiced cider, apple, banana, blueberry, cherry, coconut, grape, green apple, lemon, lemonade, chocolate, chocolate mint, cola, cotton candy, peanut butter, pie crust, pina colada, almond, cucumber, dill pickle, carnation, daffodil, gardenia, general floral, geranium, hay, hibiscus, honey suckle, lawn, lilac, lily, magnolia, mulberry, orchid, pine, spruce pine, rose, wheat, tulip, sunflower, violet, hyacinth, maple, blue spruce, basil, butterscotch, black pepper, cinnamon, clove, garlic, hazelnut, mesquite, airy fresh, band-aid, balsam, baby powder, bergamot, bubble gum, cigar, frankincense, perfume, soothing, leather, menthol, money, new car, soap, sea breeze, suntan oil, tobacco, tooth paste, campfire, invigorating, uplifting, ash tray, compost, manure, jasmine, cedar, pine, juniper, ginger, myrrh, truffle, chocolate chip cookies, pizza, anchovy, anise, and eucalyptus.

### Intermittent Application

To make a scented product cost-effective to produce and easy to use, the scented material may be applied to the substrate intermittently and/or at strategic locations, such as locations where normal handling or usage is likely to release the scent and/or wherein there is enough scented material on the substrate for a user to readily detect the scent.

If applied intermittently, the scented material may be included on the substrate in one or more stripes, which may be of virtually any width, and may be spaced any distance from one another, such as 1/16″ to 3″, (2) alternating dots, spots, triangles, rectangles and/or other designs of any size, pattern or spacing, (3) a criss-cross pattern of lines, (4) elements of a pattern or design on the substrate, (5) any other suitable designs or patterns, or (6) any combination of (1)-(5). The intermittent areas may be of any shape, size or color as long as they are sufficiently large enough to enable a person with ordinary sense of smell to detect the scent. As an example, an intermittent area may simply be a circle(s) and could be of any color(s). An intermittent scented area may instead have the color and/or shape of an object associated with the scent.

As another example, if a design element on the scented product were candy canes, some or all of the candy canes could have a scented material applied thereto. Alternatively, a design on the scented product could include the color red, and some or all of the red portions could have scented material.

The scent of the scented material could be reminiscent of a design element or color with which it is associated (e.g., for a candy cane the scent could be mint, or for the color red the scent could be cherry or strawberry), or could be any scent. Any design element(s) or color(s) of the substrate could be scented. Further, the scented material may or may not have a color, e.g., it may be transparent. Some possible, non-exhaustive and non-limiting patterns of scented material on substrates or devices are shown in the Figures submitted herewith. Any of the patterns shown, or any other pattern, could be used on a substrate or device. A substrate, such as paper, according to the invention could be individual, scented sheets or continuous rolls.

In one embodiment, the scented material positioned on the substrate or device such that the scent is preferably released by a stimulus that would be applied to the substrate or device during normal use or handling, such as writing, folding, bending, cutting, handling or inflating. For example, if the scented material is pressure activated microencapsulated material, and the substrate is gift wrapping paper it is preferred that the scented material is applied in such a manner that the normal activities of applying the wrapping paper to a package (which includes folding, cutting and handling the paper) or handling the package wrapped with the wrapping paper breaks some of the microcapsules and releases a scent.

Another way by which scented material may be applied to the substrate intermittently is to apply it in such a manner that the scented material is activated by normal use and handling. Another method by which the scented material may be applied intermittently is to position the scented material so that it is positioned on at least two sides of a completed object including the substrate. Another manner in which the scented material may be applied intermittently is to position the scented material so that it is positioned on at least two sides of a completed scented product, including the substrate. Another manner in which the scented material is applied intermittently thereon is to have the scented material associated with an object or color on a pattern of the substrate. For example, if the substrate is wrapping paper and includes multiple colors, the scented material could be on or comprised one or more colors of the pattern, or could be on or comprised one or more images of the pattern.

The scented material included with each color may or may not be the same scented material. The scented material included with a color may have a scent associated with the color. As an example, if the color is green, the scented material may have the scent of mint. Or, the scented material may have a scent hat is not associated with the color. As an example, if the color is green, the scented material may have the scent of cherry. Finally, the scented material may be applied to a sticker and the stickers may be applied to the substrate to create a scented product.

### Continuous Application

In another method according to the invention, scented material is applied to substantially all of the substrate. Continuously means that the scented material is applied to a web of substrate, at least one surface of the substrate, in either a repeating intermittent pattern, or continuously across substantially the entire width and length of the substrate or some portion thereof. For example, scented material could be applied continuously to less than 100% of the width of the surface of the substrate, and/or could be applied discontinuously along the length of the substrate, thereby creating gaps, wherein such gaps could be of any width.

The scented material could cover at least about 10% or more of the surface of the substrate, or from 10-20% or more of a surface of the substrate, or 25% or more of a surface of the substrate, or 30% or more, or 40% or more, or 50% or more, or 60% or more, or 70% or more, or 80% or more, or 90% or more of at least one surface of the substrate, or up to 100% of at least one surface of the substrate.

### EXAMPLES SHOWN IN THE DRAWING FIGURES

Turning now to the drawing figures, some preferred embodiments of the invention are described. Any of these embodiments may have any suitable substrate, including one or more of those previously described, and any suitable scented material, including one or more of those previously described. The scented material may or may not have a color and the scent of the scented material may or may not be associated with the color or design element. In one preferred embodiment, a scented product according to the invention has a substrate with a wax or plastic coating that includes scented material. In another preferred embodiment, a scented material according to the invention has a substrate with scented material applied thereto by being included in the substrate and by being placed on one or more surfaces of the substrate. Finally, scented material may be positioned on the substrate or on a coating of the substrate as a sticker or plurality of stickers.

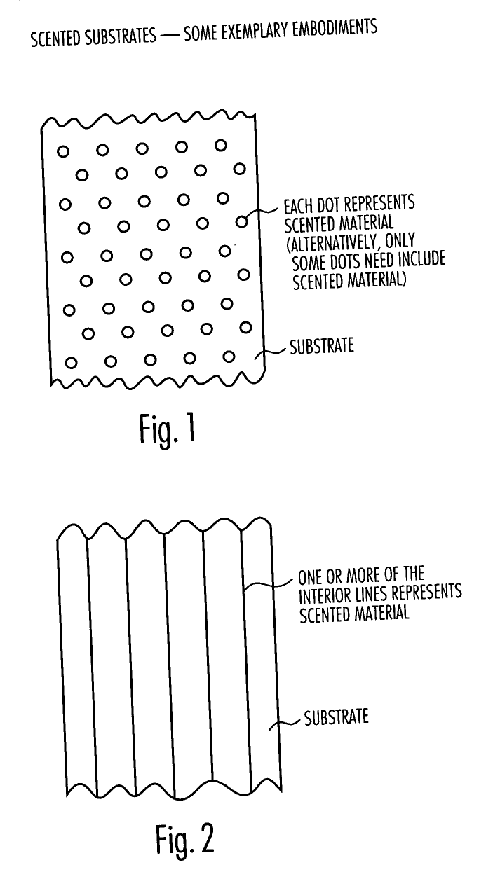

FIG. 1 is a substrate having spots or dots of scented material applied thereto all or some of the dots may have scented applied and different scented materials may be applied to different dots.

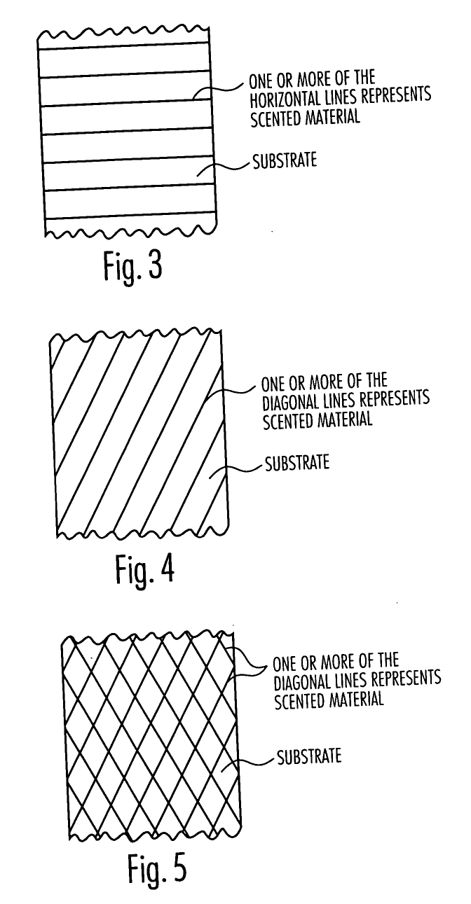

FIGS. 2, 3 and 4 show substrates having lines or stripes with scented material applied to one or more of the stripes. Different scented materials may be applied to different stripes.

FIG. 5 shows a substrate having lines or stripes in a criss-cross pattern. Scented material may be applied to one or more of the lines or stripes or applied between the lines or stripes or both applied to one or more of the lines or stripes and applied to at least part of the areas between the lines or stripes. The lines or stripes may be of any color or colors and the areas between the lines or stripes may be of any color or colors. The scented material may have a scent reminiscent of the color of the substrate to which it is applied or may have a scent unrelated to the color of the substrate.

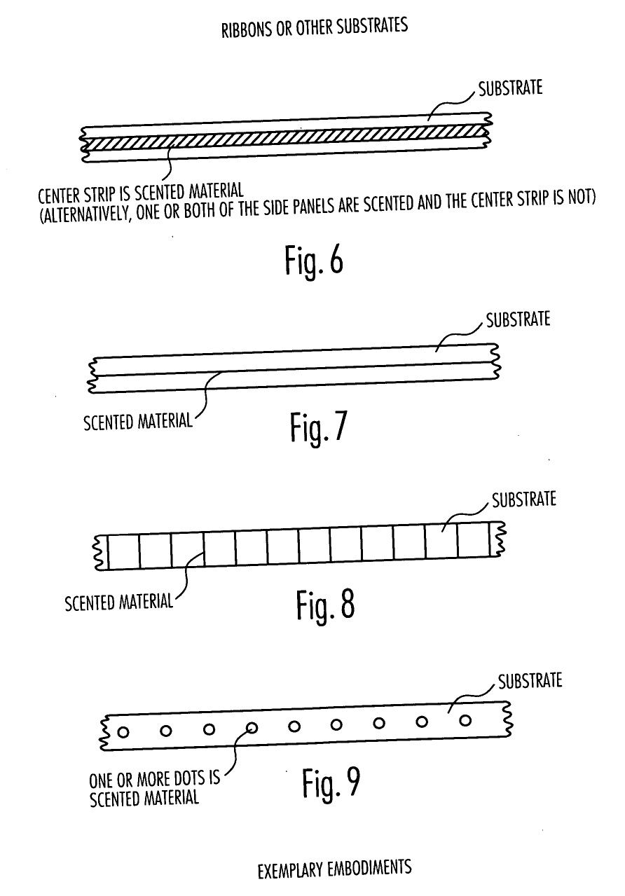

FIGS. 6-8 show elongated strips of substrate each of which has scented material applied thereto. A substrate of this type may be a ribbon, strap or other finished product and can have any suitable width, thickness or length and may be supplied on a roll or reel. The substrate may be a plastic, cloth (synthetic or natural), leather or any suitable material. As an example, the substrate may have a width of between ½″ and 2.″ Scented material is applied to the substrate in a central strip 6C. Strip 6C may be any color or width and as shown comprises about ⅓ of the surface area of one side of substrate 6A.

FIG. 7 shows a substrate 7A having a continuous stripe or line of scented material 7b applied thereto.

FIG. 8 shows a substrate 8A having repeating lines 8B applied perpendicular to axis 8C wherein substrate is applied at lines 8B.

FIG. 9 shows a substrate 9A having a plurality of dots or spots of substrate 9B applied thereto. Each of the dots or spots may be of the same scented material or may be different scented material and each may or may not be associated with a color.

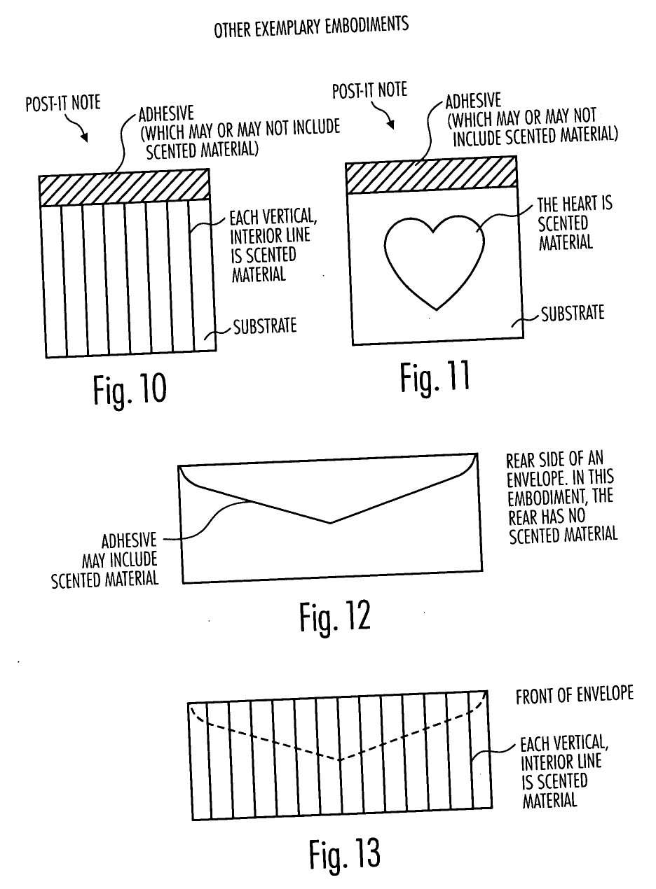

FIG. 10 shows a scented, adhesive note 10A. Note 10A includes an adhesive strip 10B, which may or may not have a scented material applied thereto, either included in the adhesive or otherwise. Non-adhesive portion 10C preferably has scented material applied to it and as shown scented material is applied as a plurality of lines or stripes 10D. The scented material could be activated when scratched, such as when someone writes on portion 10C.

FIG. 11 shows another scented, adhesive note 11A. Note 11A includes an adhesive strip 11B, which may or may not have a scented material applied thereto, either included in the adhesive or otherwise. Non-adhesive portion 11C preferably has scented material applied thereto and includes a design 10C (a heart design is shown). The design can be of any type or shape and the scented material may be of any type. In one preferred embodiment the scented material includes a pressure activated material that releases scent when pressure is applied, such as by writing on it.

FIG. 12 shows the rear side of an envelope 12A. Envelope 12A has a sealing flap 12B that has an adhesive, which may or may not have a scented material applied thereto, either included in the adhesive or otherwise.

FIG. 13 shows the front side of envelope 12A, which preferably has scented material 12D applied thereto. As shown scented material 12D includes stripes or lines 12E. In one preferred embodiment the scented material includes a pressure activated material that releases scent when pressure is applied, such as by writing on it.

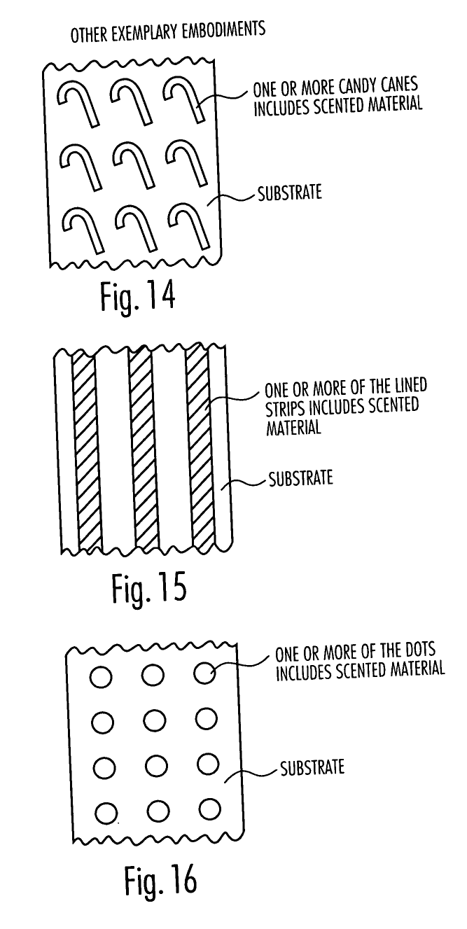

FIG. 14 shows gift wrapping material 14A comprising a substrate 14B and scented material 14C. Substrate 14B can be any of the previously-identified substrates but is preferably paper or foil. Substrate 14B is preferably between 6″ and 48″ in width and can be any length, although any suitable dimensions may be utilized. Material 14A may be supplied on a roll or reel. Substrate 14B has a plurality of images 14E applied to at least one surface and scented material may be applied to one or more of the images or applied to areas of substrate 14B between images 14E. Scented material 14C may have a scent reminiscent of the images (for example, if the images are candy canes as shown, the scented material may have the scent of peppermint) or a scent not associated with the images.

FIG. 15 shows a scented material comprising a substrate having a plurality of shapes of scented material applied thereto.

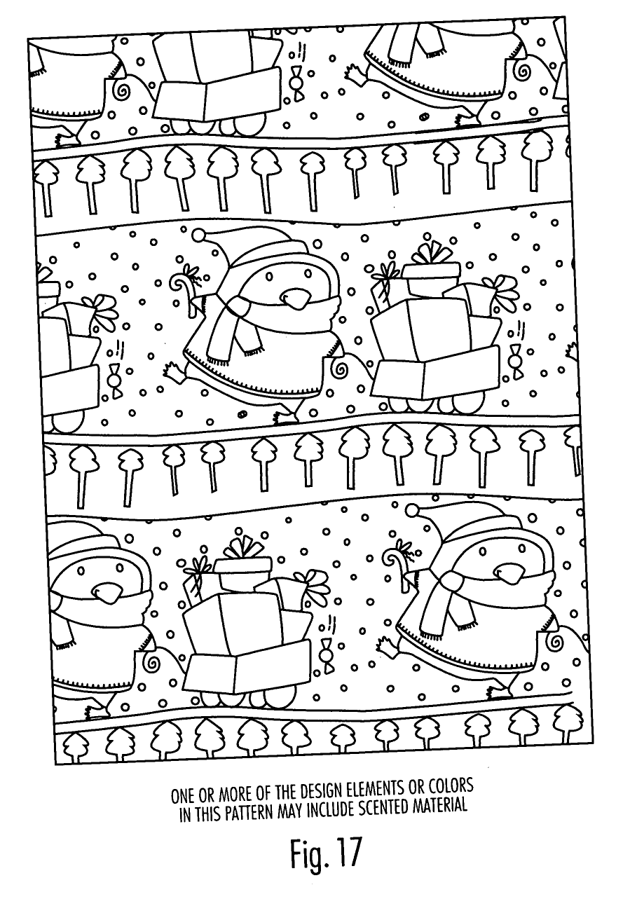

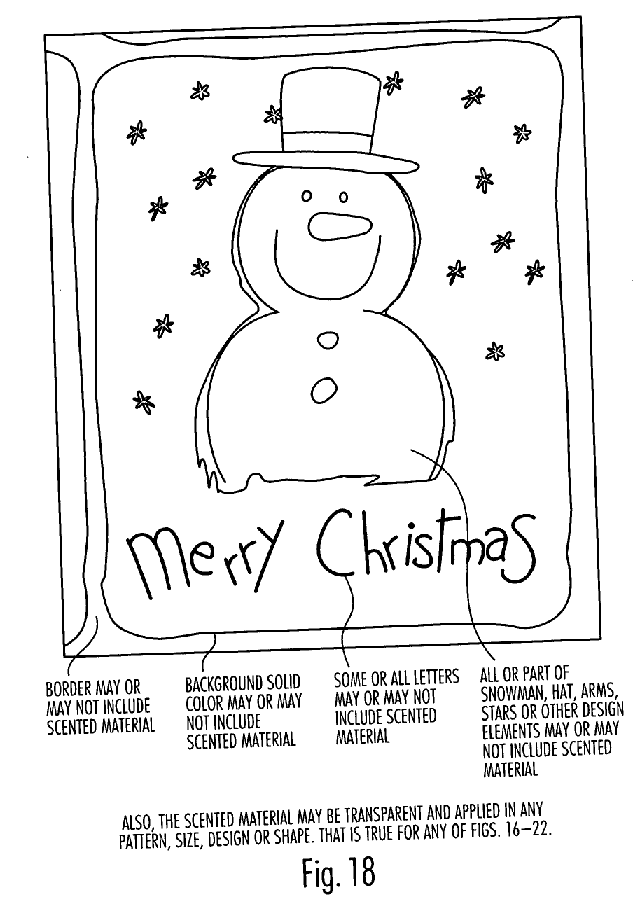

FIG. 16 is a scented product having a substrate and a scented material applied thereto as one or more spots.

FIG. 17 shows a scented product having a repeating pattern with design elements. The scented product comprises a substrate having a scented material applied thereto. The scented material may be applied intermittently or continuously and may be applied to all or part of one or more design elements.

FIG. 18 shows another scented product having a repeating pattern with design elements. The scented product comprises a substrate having a scented material applied thereto. The scented material may be applied intermittently or continuously and may be applied to all or part of one or more design elements.

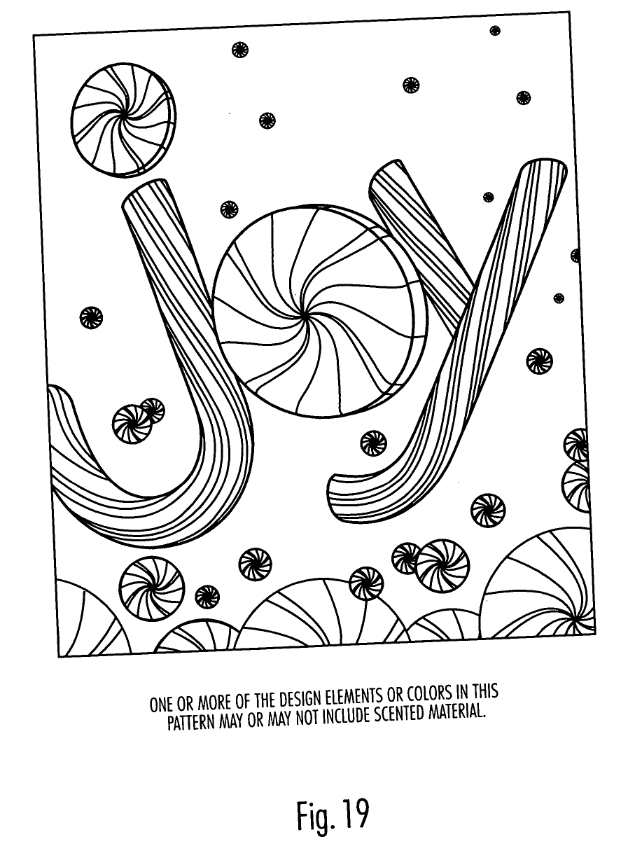

FIG. 19 shows another scented product having a repeating pattern with design elements.

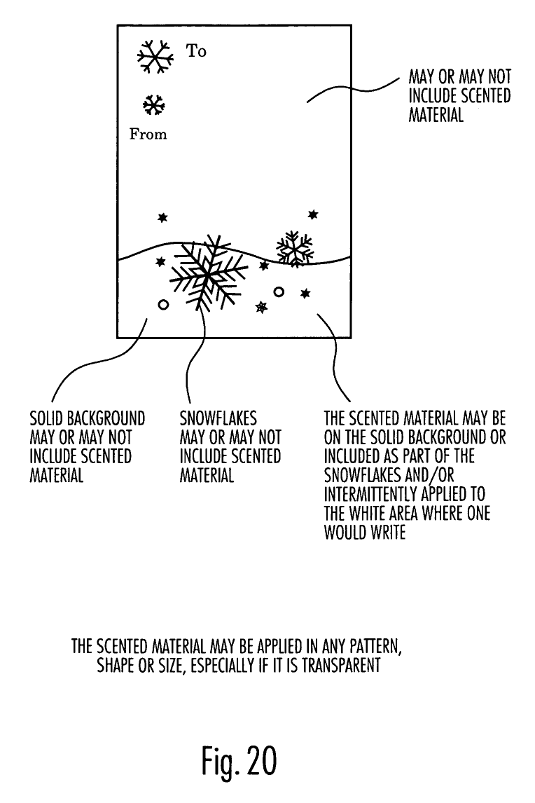

FIG. 20 shows a scented product that is a gift card comprising a substrate and a scented material applied thereto in any number of ways. The scented material may be applied to the area in which a person writes so that the act of writing releases a scent. In that case the scented material is preferably a microencapsulated formulation.

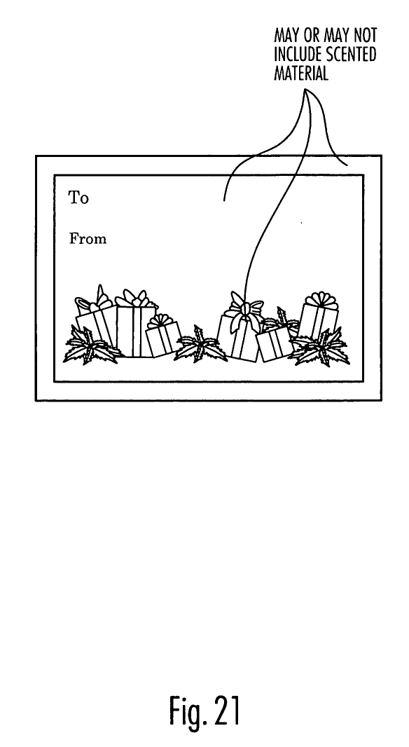

FIG. 21 shows another scented product that is a gift card comprising a substrate and a scented material applied thereto in any number of ways. The scented material may be applied to the area in which a person writes so that the act of writing releases a scent. In that case the scented material is preferably a microencapsulated formulation.

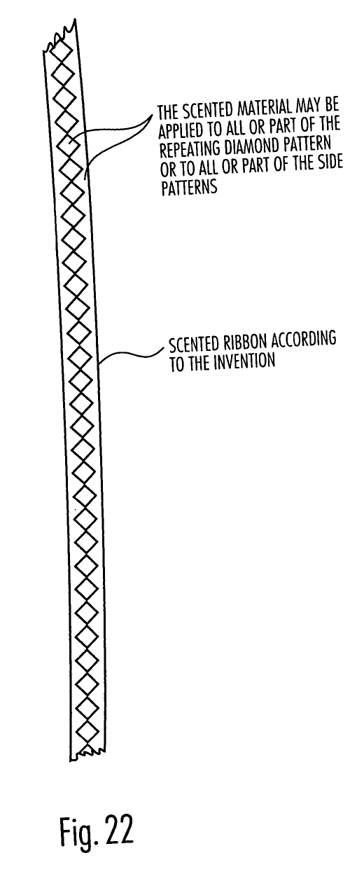

FIG. 22 is a scented material that is a ribbon comprising of a substrate and a scented material applied thereto. The scented material may be applied in any suitable manner including as being applied to the repeating dominant pattern in the center.

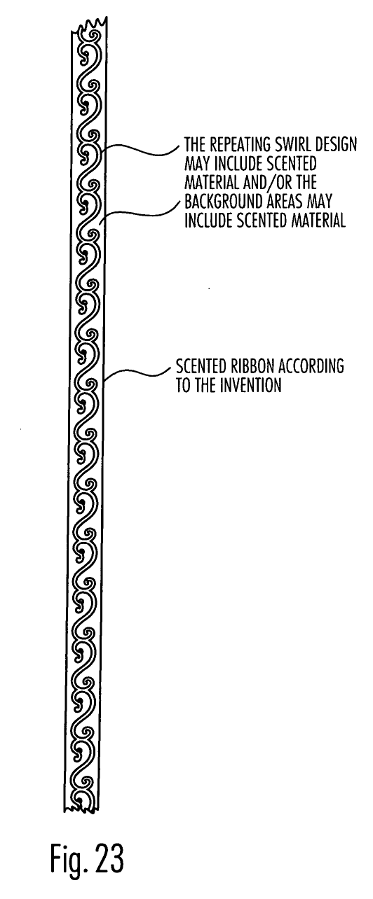

FIG. 23 shows another scented ribbon comprising of a substrate and a scented material applied thereto. The scented material may be applied in any suitable manner including as being applied to the repeating diamond pattern in the center.

The scented material may be applied to the portion of the substrate that is shown as letters or any other portions of the substrate.

Another invention disclosed herein is scented tissue paper to be used for packaging gifts, and the paper could have scented material applied in any of the previously-described ways and in any of the patterns shown in the Figures or any other pattern.

A greeting card according to the invention may have scented material applied thereto in any of the ways set forth herein. Exemplary, and non-limiting embodiments, are as follows: the scented material may be applied to the card (1) in the area in which the card is addressed or signed, or (2) in any area where the card sender writes on the card (those examples, in the act of writing may rupture microcapsules and release the scent). Or, the scented material may be applied to a color and/or image and/or pre-printed letters, numbers, words or symbols on the card.

A calendar could have scented material applied to it in any of the previously described methods and could have a theme of scents, such as pumpkin pie, turkey and mashed potatoes to create the theme of Thanksgiving dinner for November. Or, mint, pine and eggnog to create a theme associated with Christmas in December.

A diary or journal or other scented product may have a scent that evokes a particular feeling. For example, the smell of cut grass may evoke feelings of summer to encourage someone to think or write about summer. The smell of different foods, plants or settings could evoke different feelings.

A paper hat or party favor (such as a paper horn) would have scented material applied intermittently thereto in any manner described herein preferably such that the scented material is activated during the normal process of folding or handling the hat or party favor.

Some substrates including scented material (such as wrapping paper) could be provided in a roll. The substrate could simply be rolled or rolled around a tube, such as a cardboard or plastic tube. A substrate provided as a roll would include multiple areas of scented material.

### Containers and Packages

A scented product according to the invention may be placed in a container (not shown). Container is any structure in which a scented product may be temporarily or permanently stored, such as any type of metal, plastic and/or cardboard box, or a paper or plastic wrapping, or some combination of a plastic, metal and/or cardboard box and plastic and/or paper wrapping. The container may be a two-piece box (and such a container may itself be the scented product and not include a scented product). Such a box would preferably be made of plastic or cardboard, have a top section (or lid) and a bottom section (or base) having a cavity. The lid is sized to be slightly larger than base so that it can fit over the base 66. The container preferably includes scented material applied thereto in any of the previously described ways.

### SUMMARY

Having thus described different embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A scented product comprising a substrate having a scented material applied thereto, the substrate having a minimum area of one square foot and the scented material being applied to at least 15% of the area.

2. The scented product of claim 1 that further includes one or more design elements.

3. The scented product of claim 2 wherein the scented material is applied to at least one of the design elements.

4. The scented product of claim 3 wherein the scented material has a scent that is associated with the image to which it is applied.

5. The scented product of claim 1 wherein the scented material comprises a microencapsulated, scented material.

6. The scented product of claim 1 wherein the scented material comprises an essential oil.

7. The scented product of claim 1 wherein the scented material comprises an essential oil and a microencapsulated, scented material.

8. The scented product of claim 1 wherein at least some of the scented material is included in a coating applied to the wrapping material.

9. The scented product of claim 8 wherein the coating comprises one or more of the group consisting of wax, plastic and rubber.

10. The scented product of claim 8 wherein the coating is wax.

11. The scented product of claim 1 wherein the scented material is applied to at least 10% of the area of the scented product.

12. The scented product of claim 1 wherein the scented material is applied to at least 30% of the area of the scented product.

13. The scented product of claim 1 wherein the scented material is applied to at least 50% of the area of the scented product.

14. The scented product of claim 1 wherein the scented material is applied to at least 70% of the area of the scented product.

15. The scented product of claim 1 wherein the scented material is applied to at least 90% of the area of the scented product.

16. The scented product of claim 1 that has a width of at least 6″ and a length of at least 24.″

17. The scented product of claim 1 wherein the substrate is paper.

18. The scented product of a claim 1 wherein the substrate comprises one or more of the group consisting of cardboard, plastic, rubber, foil and cloth.

19. The scented product of claim 2 wherein when wrapping a package that is a 6″ cube, scented material will be positioned on each side of the six sides of the package.

20. The scented product of claim 2 wherein when wrapping a package that is a cube having dimensions of 18″×12″×3,″ scented material will be present on at least the top, bottom and two sides of the package.

21. The scented product of claim 1 wherein scented material is applied to substantially 100% of the scented product.

22. The scented product of claim 1 wherein the substrate has a weight of 60-80 grams per square yard.

23. The scented product of claim 1 wherein there is a color on the substrate and the scent of the scented material is associated with the color.

24. The scented product of claim 23 wherein the scent of the scented material is mint and the color is green.

25. The scented product of claim 1 wherein there is a color on the substrate and the scent of the scented material is not associated with the color.

26. The scented product of claim 25 wherein the scent of the scented material is pumpkin pie and the color is green.

27. The scented product of claim 1 wherein the scented material has a color.

28. The scented product of claim 27 wherein the scented material comprises a microencapsulated formula positioned on a surface of the substrate.

29. The scented product of claim 1 wherein the scented material is transparent.

30. The scented product of claim 1 wherein the scented material comprises a plurality of scented materials.

31. The scented product of claim 30 wherein each of the plurality of scented materials has the same scent.

32. The scented product of claim 30 wherein each of the plurality of scented materials has a different scent.

33. The scented product of claim 30 wherein at least one of the plurality of scented materials has a different scent than the other of the plurality of scented materials.

34. The scented product of claim 1 wherein the scented material is applied in a repeating pattern to the substrate.

35. The scented product of claim 1 wherein the scented material is applied to substantially all of the scented product.

36. A scented product being at least partially coated with a composition comprising one or more of the group consisting of wax, plastic and rubber, wherein the composition is scented.

37. The scented product of claim 36 wherein the composition is wax.

38. The scented product of claim 36 wherein the composition is plastic.

39. The scented product of claim 36 wherein the composition is rubber.

40. The scented product of claim 36 wherein the substrate is paper.

41. The scented product of claim 36 that has a color and the scented material has a scent associated with the color.

42. The scented product of claim 41 wherein the color is white and the scent is vanilla.

43. The scented product of claim 36 that has one or more design elements thereon

44. The scented product of claim 42 wherein the scented material has a scent associated with the design element.

45. The scented product of claim 44 wherein the design image is an evergreen tree and the scent is pine.

46. The scented product of claim 36 that has a color and the scent of the scented material is not associated with the color.

47. The scented product of claim 46 wherein the color is red and the scent is chocolate.

48. The scented product of claim 36 that has a design element and the scent of the scented material is not associated with the design element.

49. The scented product of claim 48 wherein the design element is a gift and the scent is cinnamon.

50. A roll of scented product, the scented product including a substrate with a scented material applied thereto.

51. The roll of scented material of claim 50 wherein the scented material is applied in a repeating pattern on the scented product.

52. The scented product of claim 1 wherein the scented material comprises one or more of the group consisting of a scented coating, a microencapsulated formulation and essential oil.
